(19) United States
(12) Patent Application Publication
(10) Pub. No.: US 2008/0026258 A1
(43) Pub. Date: Jan. 31, 2008

(54) Electron beam irradiating method, magnetic recording medium manufactured by using the method and method for manufacturing the medium

(75) Inventors: Takeshi Okino, Yokohama-shi (JP); Masatoshi Sakurai, Tokyo (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/878,162

(22) Filed: Jul. 20, 2007

(30) Foreign Application Priority Data
Jul. 28, 2006 (JP) 2006-205835

(51) Int. Cl. G11B 5/65; G21K 5/04

(52) U.S. Cl. 428/836; 250/492.3

(57) ABSTRACT

It is made possible to reduce factors of instability caused on irradiation by a rotating system in an electron beam irradiating apparatus and obtain a desired pattern stably. An electron beam irradiating method includes: providing at least an OFF state of the electron beam exposure during exposing a region corresponding to a bit pattern at a point located at a distance of a radius r from a rotation center of the substrate to the electron beam so as to make the exposure equal to r/rₒᵤₜ times that obtained when exposing a point located at a radius rₒᵤₜ of an outermost circumference in an illustrating range serving as reference.

### CROSS-REFERENCE TO RELATED APPLICATION

This application is based upon and claims the benefit of priority from prior Japanese Patent Application No. 2006-205835 filed on Jul. 28, 2006 in Japan, the entire contents of which are incorporated herein by reference.

### BACKGROUND OF THE INVENTION

1. Field of the Invention

The present invention relates to an electron beam irradiating method, a magnetic recording medium manufactured by using the electron beam irradiating method and a method for manufacturing the magnetic recording medium.

2. Related Art

In the technical trend toward the higher density of the hard disk (hereafter referred to as hard disk as well), a medium structure in which a magnetic part region issuing a magnetic signal is divided by a nonmagnetic part, i.e., the so-called medium structure of discrete type is proposed. Although a discrete type media recording and reproducing system including a data zone and a servo zone is described in JP-A 2004-110896 (KOKAI), what sort of technique is used to produce the discrete type media is not expressed clearly.

On the other hand, a technique of transferring a mold pattern of 200 nm or less onto a film, called nano imprint lithography is described in U.S. Pat. No. 5,772,905. A technique of transferring a pattern of a discrete type magnetic disk by using an imprint method is described in JP-A 2003-157520 (KOKAI). Although it is indicated in JP-A 2003-157520 (KOKAI) that a medium pattern is formed by using a stamper produced on the basis of an original disk fabricated using the electron beam lithography technique, an irradiating technique of the electron beam lithography and a pattern of the stamper are not described.

In general, the magnetic disk apparatus includes within a casing, a magnetic disk taking the shape of a torus-shaped disk, a head slider including a magnetic head, a head suspension assembly which supports the head slider, a voice coil motor (VCM), and a circuit substrate.

The inside of the magnetic disk is divided into concentric tracks cut in round slices. Each of the tracks includes sectors obtained by dividing the track at every definite angle. The magnetic disk is attached to a spindle motor and rotated.

Various digital data are recorded and reproduced by the magnetic head. Therefore, user data tracks are disposed in the circumferential direction. On the other hand, servo marks for position control are disposed in a direction striding over tracks. Each servo mark includes regions such as a preamble part, an address part and a burst part. Each servo mark includes a gap part besides the regions in some cases.

In the stamper original disk for producing the discrete type magnetic disk by using the imprint scheme, it is desired to form both a user data track region and a servo region simultaneously. Otherwise, one of the regions is added later resulting in difficult positioning and complicated processes.

In producing the original disk, its pattern can be formed by exposing photosensitive resin to an actinic radiation such as a mercury lamp, an ultraviolet ray, an electron beam and an X-ray. However, it is necessary to draw concentric circles. Therefore, irradiating with the electron beam which can be deflected is desirable. Furthermore, it is necessary to couple fine patterns such as hard disk patterns having a track pitch of submicron order with good precision. Therefore, a scheme of moving the stage continuously is more desirable than the step-and-repeat scheme in which the stage is made to stand still when irradiating with the electron beam is conducted and the stage is moved to the next field after all patterns in one field have been drawn.

It is desirable to use an electron beam irradiating apparatus of a continuous stage movement scheme including a moving mechanism to move the stage in one horizontal direction and a rotation mechanism to rotate the stage, from among electron beam irradiating apparatuses capable of drawing concentric circles. In this electron beam irradiating apparatus, a spot beam from one point on a movement axis is applied to the photosensitive resin on the substrate place on the stage to conduct electron beam exposure. If any external force is not applied to the electron beam for deflection, the distance between the rotation center of the substrate and the irradiation position with the electron beam increases with time, and consequently a spiral shape is drawn. Therefore, concentric circles can be drawn by deflecting the electron beam while gradually changing the deflection strength every rotation in the electron beam exposure process.

As the rotation form of the stage, CLV (Constant Linear Velocity) or CAV (Constant Angular velocity) is typically used. When conducting exposure using an actinic radiation such as an electron beam, the CLV is desirable because the amount of exposure per unit area (and per unit length) of the electron beam can be made constant. In that case, however, the number of rotations of the motor must be changed according to the radius. Also in a moving mechanism which moves the stage in one horizontal direction, its feed velocity must be changed according to the radius.

When the rotation velocity or the feed velocity is thus changed during exposure, the control is apt to become unstable as compared with when the rotation velocity or the feed velocity is made constant. For example, a shift in the feed velocity appears as a track pitch error in the pattern. If there is a defect such as a deviation in the pattern, there is a fear that noise or errors will be caused in magnetic recording media to which the pattern is transferred.

On the other hand, when conducting exposure with the CAV, the motor can be rotated with a constant number of rotations and consequently the rotation control is stabilized. When the stage is fed at an equal pitch even in the moving mechanism which moves the stage in one horizontal direction, it is not necessary to change its feed velocity according to the radius and the stage can be fed at a constant velocity, resulting in stabilized feed control. However, exposure using an actinic radiation such as an electron beam as it is poses a problem that the exposure per unit area (and per unit length) is large on the inner circumference side whereas the exposure per unit area (and per unit length) becomes small on the outer circumference side.

### SUMMARY OF THE INVENTION

It is an object of the present invention to provide an electron beam irradiating method which makes it possible to reduce the factors of instability caused on the irradiation by the rotation system of the electron beam irradiating apparatus and obtain a desired pattern stably, when attempting to irradiate an original disk used to manufacture a discrete type magnetic medium patterning stamper by using an electron beam irradiating apparatus which rotates a stage at CAV, and provide a magnetic recording medium manufactured by using the electron beam irradiating method, and a method for manufacturing the magnetic recording medium.

According to a first aspect of the present invention, there is an electron beam irradiating method for irradiating a photosensitive resin film with an electron beam to draw a pattern formed of a plurality of bits by using an electron beam irradiating apparatus, the electron beam irradiating apparatus including a rotating mechanism which rotates a stage on which a substrate having a photosensitive film formed thereon is placed at constant angular velocity, a moving mechanism which moves the stage in one horizontal direction, and an electron beam irradiating portion which irradiates the photosensitive film with an electron beam, the method including: providing at least an OFF state of the electron beam exposure during exposing a region corresponding to a bit pattern at a point located at a distance of a radius r from a rotation center of the substrate to the electron beam so as to make the exposure equal to r/rₒᵤₜ times that obtained when exposing a point located at a radius rₒᵤₜ of an outermost circumference in an illustrating range serving as reference.

According to a second aspect of the present invention, there is a method for manufacturing magnetic recording medium by using the imprint method, the method including: forming a resist original disk by irradiating an electron beam by using the electron beam irradiating method according to the first aspect; forming a stamper to be used for an imprint method by using the resist original disk; and forming a magnetic recording medium by using the stamper.

According to a third aspect of the present invention, there is a magnetic disk medium manufactured by using the method according to the second aspect.

### BRIEF DESCRIPTION OF THE DRAWINGS

FIG. 1(a) to 1(c) is a diagram showing ON/OFF examples of a beam in an electron beam irradiating method according to a first embodiment;

FIG. 2(a) to 2(c) is a diagram showing examples of irradiation with a beam in the electron beam irradiating method according to the first embodiment;

FIG. 3 is a diagram showing an outline of an electron beam irradiating apparatus used in the electron beam irradiating method according to the first embodiment;

FIGS. 4A to 4G are sectional views in manufacturing processes of a stamper used to manufacture a discrete type magnetic recording medium according to a second embodiment;

FIGS. 5A to 5F are sectional views in manufacturing processes of the discrete type magnetic recording medium according to the second embodiment; and

FIGS. 6A to 6D are sectional views in manufacturing processes of the discrete type magnetic recording medium according to a second example.

### DETAILED DESCRIPTION OF THE INVENTION

### First Embodiment

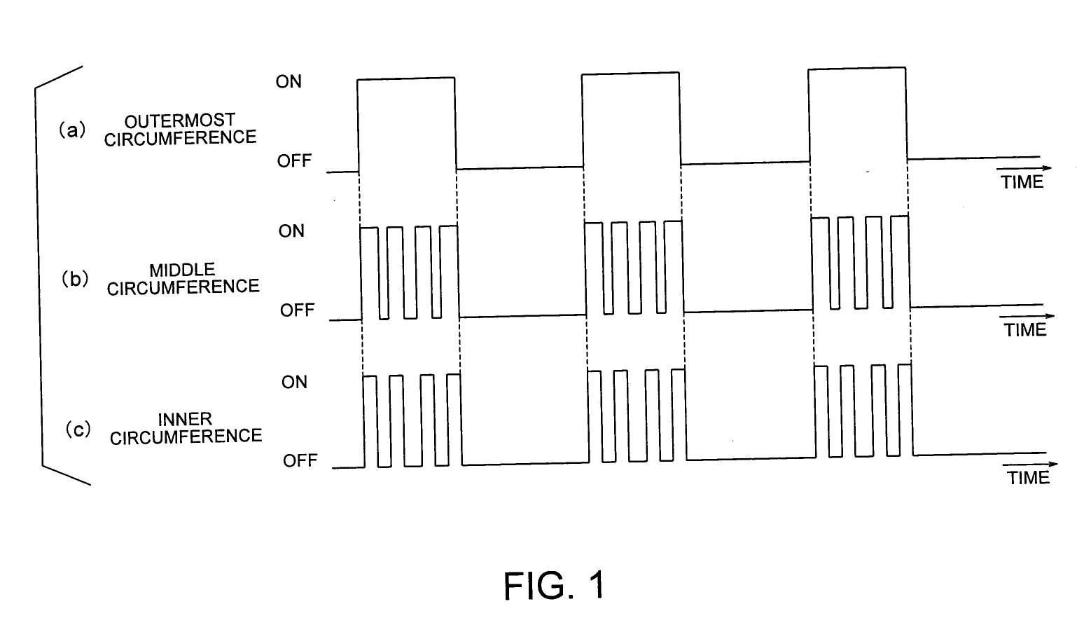

An electron beam irradiating method according to a first embodiment of the present invention will now be described with reference to FIGS. 1(a) to 3.

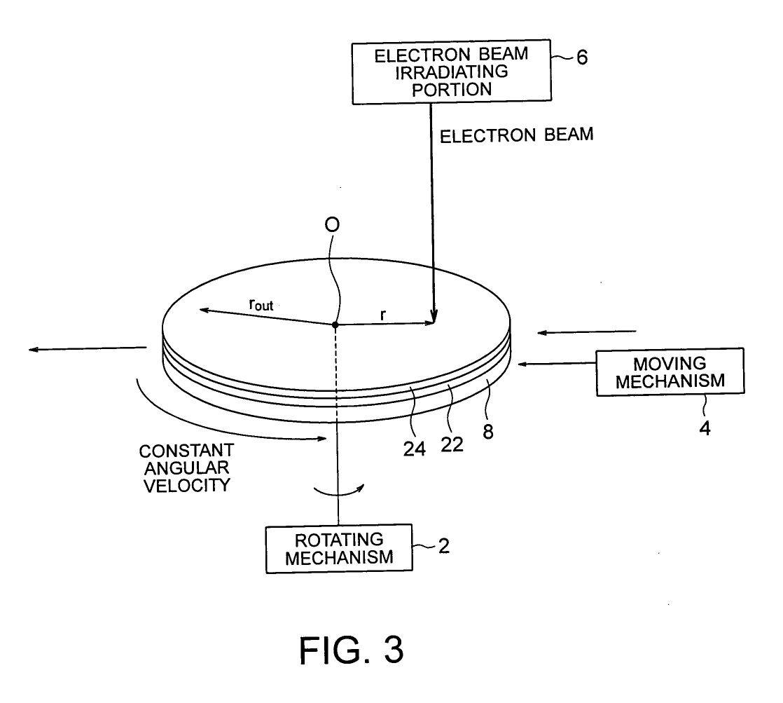

The electron beam irradiating method according to the present embodiment is executed by using an electron beam irradiating apparatus shown in FIG. 3. The electron beam irradiating apparatus includes a stage 8 on which a substrate 22 having a photosensitive resin film 24 formed thereon is placed, a rotating mechanism 2 which rotates the stage 8 at a constant angular velocity, a moving mechanism 4 which moves the stage 8 in one horizontal direction, and an electron beam irradiating portion 6 which irradiates the photosensitive resin film 24 with an electron beam. In the electron beam irradiating method according to the present embodiment, the photosensitive resin film 24 is irradiated with the electron beam to draw a pattern formed of a plurality of bits. When exposing a region corresponding to a bit pattern at a point located at a distance of a radius r from a rotation center of the stage 8, i.e., a rotation center O of the substrate 22 to the electron beam, an OFF state is formed during exposure of the region corresponding to the bit pattern so as to make the exposure equal to r/rₒᵤₜ times that obtained when exposing a point located at an outermost radius rₒᵤₜ of an illustrating range serving as the reference. By the way, the moving mechanism 4 may be formed so as to move the stage 8 in the horizontal direction at a constant velocity. Because the track pitch can be made constant by moving the stage 8 in the horizontal direction at a constant velocity.

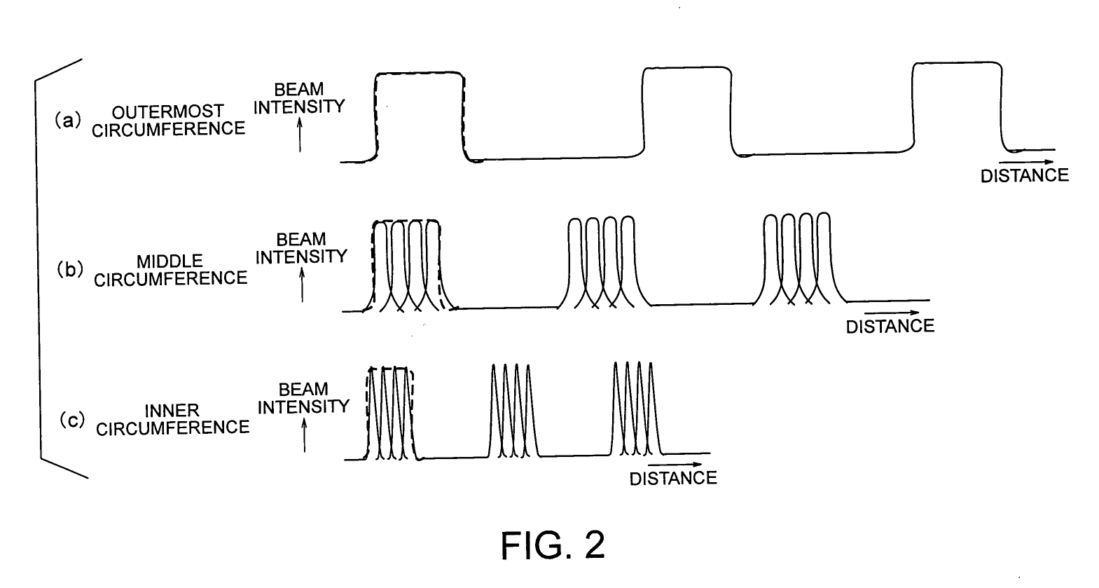

The method according to the present embodiment will now be described with reference to FIG. 1(a) to 2(c). FIG. 1(a), 1(b) and 1(c) show waveform examples of ON/OFF of the electron beam in the outermost circumference (radius rₒᵤₜ), a middle circumference, and an inner circumference with the abscissa indicating the time. FIG. 2(a), 2(b) and 2(c) show irradiation examples with the electron beam in the outermost circumference, the middle circumference, and the inner circumference with the abscissa indicating the distance.

When exposing a region corresponding to a bit pattern at a point located at a distance of a radius r, an OFF state of the electron beam exposure is formed during exposure of the region corresponding to the bit pattern so as to make the exposure equal to r/rₒᵤₜ times that obtained when exposing a point located at a radius rₒᵤₜ of the outermost circumference serving as the reference, as shown in FIG. 1(a), 1(b) and 1(c). By doing so, the exposure does not become excessively large even on the inner circumference side where the linear velocity is slow and irradiation can be conducted as represented by dotted lines in FIG. 2(a), 2(b) and 2(c). In FIG. 2(a), 2(b) and 2(c), solid lines represent waveforms of the actual electron beam. A dotted line representing overlapping of them coincides with a waveform of the actual electron beam in FIG. 2(a), whereas it becomes an envelope curve of the waveform of the actual electron beam in each of FIGS. 2(b) and 2(c).

It is desirable to form the OFF state finely so as to prevent the pattern from being interrupted in a pattern region corresponding to one bit and so as to make beams partially overlap each other. And it is desirable that there are a plurality of OFF states. Furthermore, since it is desirable that symmetry is maintained in the pattern region, it is desirable that appearance timing of the ON state divided by the OFF states before a time point in the region corresponding to the bit pattern is symmetrical to that after the time point. When bits to be exposed are consecutive, such as when exposing a groove part in a discrete track medium, it is desirable that appearance timing of the ON state divided by the OFF states is periodically uniform in the consecutive pattern.

The photosensitive resin used in the electron beam irradiating method according to the present embodiment may be either of a positive type resist, a negative type resist, a chemical amplifier type containing a material which generates acid in response to exposure, and a non-chemical amplifier type. However, the positive type resist of the non-chemical amplifier type is favorable because it is favorable in sensitivity to the electron beam and favorable in resolution as well. Besides, a material containing PMMA (polymethyl methacrylate) or novolac resin as a main component can be used. The dry etching resistance does not matter.

The exposure may be started from either of the inner circumference side and the outer circumference side. Or the exposure may be conducted by dividing the region into several zones. It can be accomplished to form the OFF state during the exposure of the region corresponding to the bit pattern by supplying a deflection signal so as to blank the electron beam in the electron beam irradiating apparatus.

According to the present embodiment, the exposure per unit area (per unit length) becomes the same in any radius position no matter which of the inner circumference side, the middle circumference side and the outer circumference side the radius position is located in, as heretofore described. When irradiating the original disk used to produce the discrete type magnetic medium patterning stamper, therefore, it is possible to reduce factors of instability caused on irradiation by the rotation system in the electron beam irradiating apparatus and obtain a desired pattern stably.

### Second Embodiment

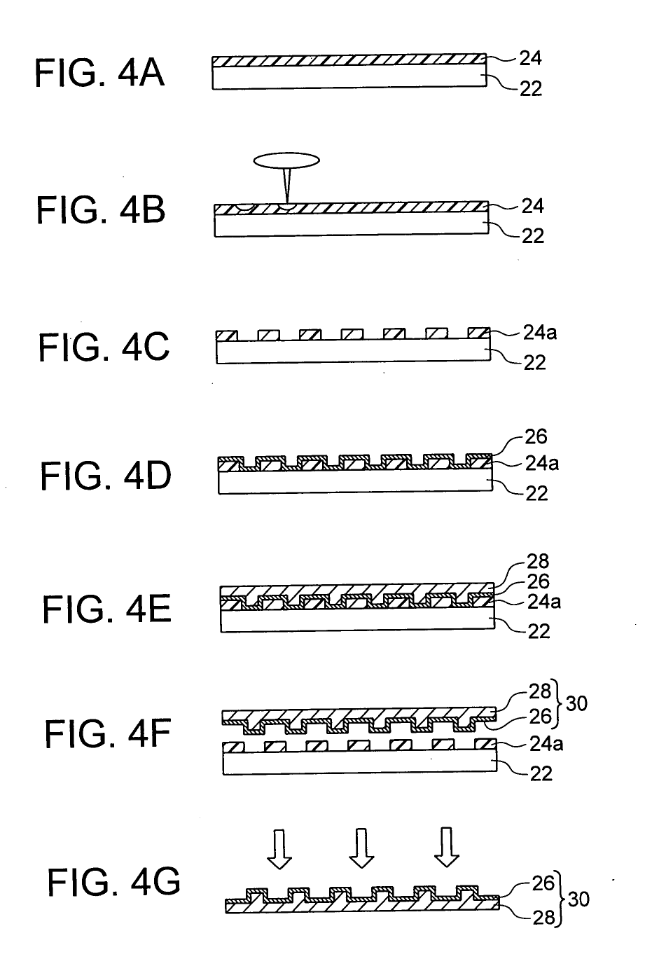

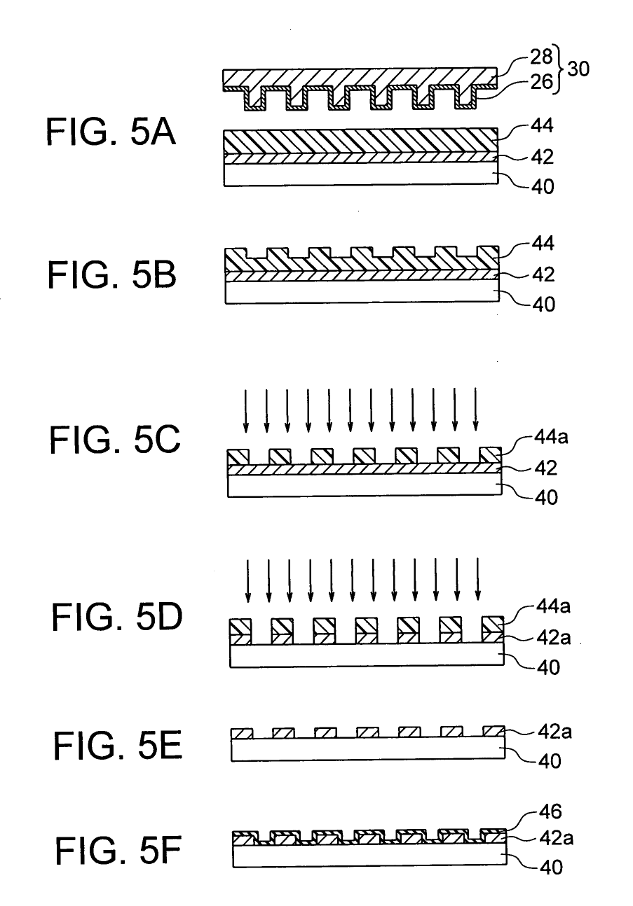

A discrete type magnetic disk medium according to a second embodiment will now be described with reference to FIGS. 4A to 5F. The magnetic disk medium according to the present embodiment is a magnetic film-patterned discrete track medium. When manufacturing it, the electron beam irradiating method described with reference to the first embodiment is used in the exposure process. Hereafter, the manufacturing process of the magnetic disk medium according to the present embodiment will be described.

Photosensitive resin (hereafter referred to as resist) 24 is applied on to a substrate 24 (see FIG. 4A). The resist 24 is exposed to an electron beam as shown in FIG. 4B.

Thereafter, the resist 24 is developed by using a developing solution to form a resist pattern 24a (FIG. 4B shows the case where a positive type resist is used). A resist original disk is produced (see FIG. 4C). A post-bake process may be executed before developing the resist 24.

Subsequently, a thin conductive film 26 is formed on the resist pattern 24a of the resist original disk by conducting Ni sputtering or the like (see FIG. 4D). At this time, the resist pattern 24a is made thick enough to maintain the shape of concave parts of the resist pattern 24a. Thereafter, a Ni film 28 is buried fully in the concave parts of the resist pattern 24a by electroforming and formed to have a desired thickness (see FIG. 4E).

Subsequently, the Ni film 28 is stripped from the resist original disk formed of the resist 24a and a substrate 22. As a result, a stamper 30 formed of the conductive film 26 and the Ni film 28 is formed (see FIG. 4F). Thereafter, oxygen RIE (reactive ion etching) is conducted to remove the resist adhered to the stamper 30 (see FIG. 4G).

As shown in FIG. 5A, a magnetic layer 42 serving as a recording layer is formed on a substrate 40. A magnetic disk medium substrate obtained by applying resist 44 onto the magnetic layer 42 is prepared. The resist 44 applied onto the magnetic disk medium substrate is imprinted by using the stamper 30 (see FIG. 5A). Thus, the pattern of the stamper 30 is transferred onto the resist 44 (see FIG. 5B).

Subsequently, the resist 44 is etched by using the pattern transferred onto the resist 44 as a mask. As a result, a resist pattern 44a is formed (see FIG. 5C). Thereafter, the magnetic layer 42 is subjected to ion milling by using the resist pattern 44a as a mask (see FIG. 5D). Subsequently, the resist pattern 44a is removed by dry etching or chemicals. As a result, a discrete magnetic layer 42a is formed (see FIG. 5E).

Subsequently, a protection film 46 is formed on the whole surface to complete the magnetic disk medium (see FIG. 5F). A process for burying a nonmagnetic magnetic material into concave parts such as grooves may be provided.

Although the shape of the substrate on which the pattern is formed by using the fabrication method according to the present embodiment is not especially restricted, a substrate taking the shape of a disk such as a silicon wafer is desirable. The disk may have a notch or an orientation flat. As the substrate, a glass substrate, an Al alloy substrate, a ceramic substrate, a carbon substrate, a compound semiconductor substrate or the like can be used. As the glass substrate, amorphous glass or crystallized glass can be used. As the amorphous glass, soda lime glass, aluminosilicate glass, or the like can be used. As the crystallized glass, there is lithium crystallized glass. As the ceramic substrate, a sintered body containing aluminum oxide, aluminum nitride, silicon nitride or the like as the main component, or substrates obtained by fiber-reinforcing these sintered bodies can be used. As the compound semiconductor substrate, GaAs, AlGaAs or the like is used.

As for the magnetic disk medium shape, a disk shape, especially the torus-shape is favorable from the viewpoint of the scheme. However, its size is not especially restricted from the viewpoint of the scheme. However, its size is desired to be 3.5 inch or less so as to prevent the time of irradiating with the electron beam from becoming excessively long. In addition, its size is desired to be 2.5 inch or less so as to prevent the press capability used at the time of imprinting from becoming excessively large. From the viewpoint of mass productivity, it is more desirable that the size is 1.8 inch or less, such as 0.85 inch, 1 inch or 1.8 inch, at which the electron beam irradiating time is relatively short and a relatively low pressure can be used at the time of imprinting. Either of one side and both sides may be used as the magnetic disk medium.

The inside of the magnetic disk medium is divided into concentric tracks cut in round slices. Each of the tracks includes sectors obtained by dividing the track at every definite angle. The magnetic disk is attached to a spindle motor and rotated. Various digital data are recorded and reproduced by the magnetic head. Therefore, user data tracks are disposed in the circumferential direction. On the other hand, servo marks for position control are disposed in a direction striding over tracks. Each servo mark includes regions such as a preamble part, an address part having track or sector number information written therein, and a burst part used to detect the relative position of the head to the track. Each servo mark includes a gap part besides the regions in some cases.

From the viewpoint of improvement in recording density, the track pitch is required to be narrower. Even in one track, it is necessary to form a nonmagnetic part serving as a separation part for a user data region part and a magnetic part serving as a data recording region, form address bits in a corresponding servo region, and form burst marks. At the time of cutting, therefore, it is required to conduct irradiation so as to form one track with several to several tens circumferences. If the number of cutting circumferences is small, then the shape resolution becomes low and it becomes impossible to reflect the pattern shape favorably. If the number of cutting circumferences is large, there is a problem that the control signals become complicated and become large in capacity. Therefore, it is desirable that one track is formed of circumferences numbering in the range of six to thirty-six inclusive. In addition, it is advantageous in the design of the pattern arrangement that the number of circumferences has a large number of divisors.

Since the sensitivity of the exposed film is typically uniform in the plane, it is desirable to rotate the stage in the electron beam irradiating apparatus while keeping the linear velocity constant. For example, if it is attempted to form one track with cutting of twelve circumferences when tracks in one user data region have a pitch of 300 nm, the cutting track pitch becomes 300 nm÷12=25 nm. It is desirable that the cutting track pitch is at most the beam diameter in order to eliminate an insufficient exposure area or an undeveloped area.

As for the stage in the electron beam irradiating apparatus, an optical system for scanning with an electron beam, and signals for activating them, it is necessary to accomplish synchronization among the blanking point, its signal and stage operation signals for controlling movement in the radial direction and the rotation direction.

The stamper used to manufacture the magnetic disk medium according to the present embodiment may take the shape of a disk, a torus-shape or another shape. It is desirable that the stamper has a thickness in the range of 0.1 mm to 2 mm inclusive. If the stamper is too thick, the strength is not obtained. If the stamper is thicker than needed, it takes time to conduct electroforming or the film thickness difference becomes large. It is desirable that the stamper is larger in size than the medium. However, the stamper size is not especially restricted from the scheme.

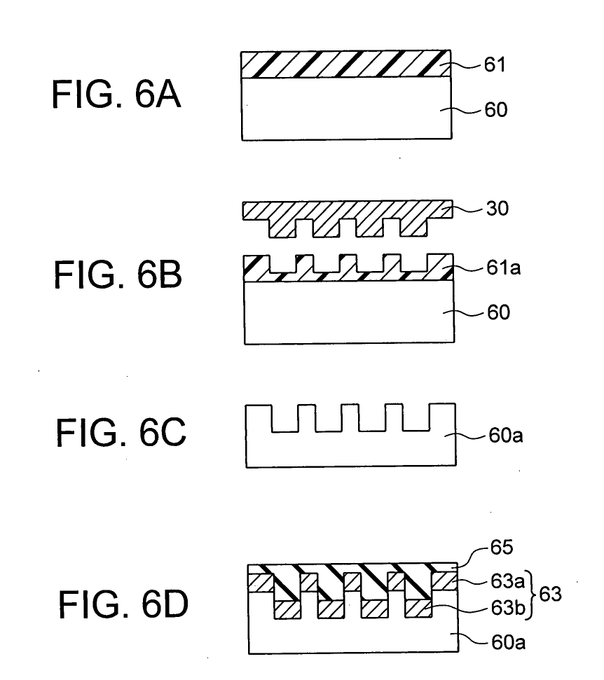

The discrete-type magnetic disk medium according to the second embodiment is a magnetic film-patterned discrete track medium as shown in FIG. 5F. Alternatively, the discrete-type magnetic disk medium according to the second embodiment may be a substrate-patterned discrete track medium as shown in FIG. 6 described later. In the exposure process for manufacturing the substrate-patterned discrete track medium, the electron beam irradiating method described with reference to the first embodiment is used.

Examples of the present invention will now be described.

### First Example

A magnetic disk medium according to a first example of the present invention will now be described with reference to FIGS. 4A to 5F.

An electron beam irradiating apparatus with an acceleration voltage of 50 kV having an electron gun emitter of ZrO/W thermal electric field emission type including an electron gun, a condenser lens, an object lens, a blanking electrode and a deflector is used.

On the other hand, resist ZEP-520 produced by NIPPON ZEON CORP. is diluted to twice with anisole, and filtered by using a 0.2-μm membrane filter. Thereafter, an 8-inch silicon wafer substrate 22 subjected to HMDS processing is spin-coated, and pre-baked at 200° C. for three minutes to form a resist 24 having a film thickness of 0.1 μm (see FIG. 4A).

The substrate 22 is conveyed to a predetermined position in the electron beam irradiating apparatus by a conveyance system in the apparatus. In vacuum, exposure is conducted to obtain a concentric circle pattern under the following conditions (see FIG. 4B).

Exposed part radius: 4.8 mm to 10.2 mm

Number of sectors per track: 150

Number of bits per sector: 4000

Track pitch: 300 nm

Feed quantity per revolution: 20 nm

The number of exposure circumferences per track: 15 circumferences

The number of exposure circumferences per burst mark: 10 circumferences

The number of revolutions: 600 rpm (constant)

Irradiation is conducted in a concentric circular form while gradually increasing the deflection strength during one revolution.

The address part includes a preamble pattern, a burst pattern, a sector and track address pattern, and a gap pattern. A track part occupies an area which amounts to 90% of the sector. When exposing a region corresponding to a bit pattern at a point located at a distance of a radius r, a signal is output from a signal source and blanking is applied so as to form three OFF states during exposure of the region corresponding to the bit pattern and thereby make the exposure equal to r/rₒᵤₜ times that used when exposing a point located at a distance of a radius rₒᵤₜ of the outermost circumference which serves as reference. The ON state is divided into four ON states having ratios 1:2:2:1 by executing blanking three times. Also in the case where bits to be exposed are consecutive, blanking is conducted in the same way. In the consecutive part, the ON state of the previous bit and the ON state of the next bit are consecutive to form an ON state.

As for a signal for forming the pattern, a signal to be sent to a stage drive system in the exposure apparatus, and the electron beam deflection control, a signal source capable of generating them in synchronism is used. During the exposure, the stage is rotated with a CAV of a linear velocity 600 rpm and the stage is moved at a constant velocity of 20 nm in the rotation radius direction as well every rotation.

After the exposure, the silicon wafer substrate 22 is immersed in a developing solution (for example, ZED-N50 (produced by NIPPON ZEON CORP.) for 90 seconds and developed. Thereafter, the silicon wafer substrate 22 is immersed in a rinse solution (for example, ZMD-B (produced by Nihon Zeon Company) for 90 seconds and rinsed. The silicon wafer substrate 22 is dried by air blow, and a resist original disk having convex parts and concave parts is produced (see FIG. 4C).

A conductive film 26 is formed on the resist original disk by using the sputtering method. Pure nickel is used as the target. Then, sputtering is conducted in a chamber which is vacuumed up to 8×10⁻³ Pa, filled with argon gas and adjusted to 1 Pa, with DC power of 400 W for 40 seconds. As a result, a conductive film 26 of 30 nm is obtained (see FIG. 4D).

The resist original disk having the conductive film 26 is electroformed by using a nickel sulfamate plating solution (NS-160 produced by SHOWA KAGAKU CO., LTD.) for 90 minutes (see FIG. 4E). The electroforming bath conditions are as follows:

Nickel sulfamate: 600 g/L

Boric acid: 40 g/L

Surface active agent (sodium lauryl sulfate): 0.15 g/L

Temperature of solution: 55° C.

P.H: 4.0

Current density: 20 A/dm²

The electroformed film 28 has a thickness of 300 μm. Thereafter, the electroformed film 28 is stripped from the resist original disk. As a result, a stamper 30 including the conductive film 26, the electroformed film 28 and the resist residue is obtained (see FIG. 4F).

The resist residue is removed by using the oxygen plasma ashing method. As for the oxygen plasma ashing, plasma ashing is conducted in a chamber which is filled with oxygen gas at a rate of 100 ml/min and which is adjusted to a vacuum of 4 Pa, at 100 W for 20 minutes (see FIG. 4G). The father stamper 30 including the conductive film 26 and the electroformed film 28 is obtained. Thereafter, an unnecessary part of the resultant stamper 30 is stamped out by a metal blade, resulting in an imprinting stamper 30.

The stamper 30 is subjected to ultrasonic cleaning with acetone for 15 minutes. Thereafter, in order to increase the mold release property at the time of imprinting, the stamper 30 is immersed in a solution obtained by diluting fluoroalkylsilane [CF₃(CF₂)₇CH₂ CH₂Si(OMe)₃] (TSL8233 produced by GE TOSHIBA SILICONES) to 5% with ethanol, for 30 minutes. After the solution is blown off by a blower, annealing is conducted at 120° C. for one hour.

On the other hand, a magnetic recording layer 42 is formed on a 0.85 inch torus-shaped glass substrate 40 by using the sputtering method as a patterned substrate. A novolac resist 44 (S1801 produced by ROHM AND HAAS ELECTRONIC MATERIALS) is spin-coated on the magnetic recording layer 42 at the number of revolutions of 3,800 rpm (see FIG. 5A). Thereafter, a pattern is transferred onto the resist 44 by pressing the stamper 30 with 2,000 bar for one minute (see FIG. 5B). The resist 44 having the transferred pattern is exposed to UV (ultraviolet rays) for five minutes, and then heated at 160° C. for 30 minutes.

Oxygen RIE is conducted on the substrate imprinted as heretofore described under an etching pressure of 2 mTorr by using an ICP (inductively coupled plasma) etching system (see FIG. 5C). Subsequently, the magnetic recording layer 42 is etched using Ar ion milling (see FIG. 5D). After the magnetic recording layer 42 is etched, oxygen RIE is conducted with 400 W and 1 Torr in order to strip the etching mask 44a formed of the resist (see FIG. 5E). After the etching mask 44a is stripped, a DLC (Diamond Like Carbon) film having a thickness of 3 nm is formed as a protection film 46 by using the CVD (chemical vapor deposition) (see FIG. 13F). In addition, a lubricant is applied to have a thickness of 1 nm by using the dipping method.

The media thus imprinted and patterned are incorporated into a magnetic recording apparatus to detect a signal. As a result, a favorable burst signal is obtained, and head position control can be conducted suitably.

### Second Example

A manufacturing method of a magnetic recording medium according to a second example of the present invention will be described with reference to FIGS. 6A to 6D. The magnetic recording medium manufactured by using the manufacturing method of the present example is a substrate-patterned discrete track medium.

First, an imprint stamper is fabricated by using a technique similar to that shown in FIGS. 4A to 4G, and especially by using the irradiating method according to the first embodiment in FIG. 4B.

Subsequently, a convex-concave patterned substrate is fabricated by using the imprint lithography method as described hereafter. As shown in FIG. 6A, a resist 61 for imprinting is applied to a substrate 60. Subsequently, as shown in FIG. 6B, a stamper 30 is opposed to the resist 61 on the substrate 60. Pressure is applied to press the stamper 30 against the resist 61 to transfer a convex part pattern on the surface of the stamper 30 onto the surface of the resist 61. Thereafter, the stamper is removed. As a result, a concave-convex pattern is formed on the resist 61, resulting in a resist pattern 61a (see FIG. 6B).

Subsequently, the substrate 60a having the concave-convex pattern formed thereon is obtained by etching the substrate 60 with the resist pattern 61a used as a mask. Thereafter, the resist pattern 61a is removed (see FIG. 6C).

Subsequently, as shown in FIG. 6D, a magnetic film 63 formed of a material suitable for perpendicular recording is formed on the substrate 60a. At this time, a magnetic film formed on convex parts of the substrate 60a becomes a convex part magnetic substance part 63a, and a magnetic film formed on concave parts of the substrate 60a becomes a concave part magnetic substance part 63b. It is desirable to form a laminated film of a soft magnetic underlying layer and a ferromagnetic recording layer as the magnetic film 63. In addition, a protection film 65 formed of carbon is provided on the magnetic film 63 and a lubricant is applied to fabricate a magnetic recording medium.

The media thus imprinted and patterned are incorporated into a magnetic recording apparatus to detect a signal. As a result, a favorable burst signal is obtained, and head position control can be conducted suitably.

### Comparative Example

Electron beam irradiation is conducted so as to make the exposure in each circumference the same as that in the first example while rotating the substrate at CLV and changing the feed velocity in the radial direction according to the radius. Thereafter, a magnetic recording medium is fabricated by using a method similar to that in the first example.

The media thus imprinted and patterned are incorporated into a magnetic recording apparatus to detect a signal. As a result, the signal noise is large as compared with the first example, and an error is caused at the time of signal reproduction in a part of the media.

According to the electron beam irradiating method in the embodiments of the present invention, it becomes possible to conduct stable rotation and feed in the horizontal direction in the electron beam irradiating apparatus as heretofore described. As a result, it becomes possible to fabricate a stamper and a magnetic recording medium having a stable pattern shape and reduce signal errors and noise on the magnetic recording media.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. An electron beam irradiating method for irradiating a photosensitive resin film with an electron beam to draw a pattern formed of a plurality of bits by using an electron beam irradiating apparatus, the electron beam irradiating apparatus including a rotating mechanism which rotates a stage on which a substrate having a photosensitive resin film formed thereon is placed at constant angular velocity, a moving mechanism which moves the stage in one horizontal direction, and an electron beam irradiating portion which irradiates the photosensitive resin film with an electron beam, the method comprising:
providing at least an OFF state of the electron beam exposure during exposing a region corresponding to a bit pattern at a point located at a distance of a radius r from a rotation center of the substrate to the electron beam so as to make the exposure equal to r/rₒᵤₜ times that obtained when exposing a point located at a radius rₒᵤₜ of an outermost circumference in an illustrating range serving as reference.

2. The method according to claim 1, wherein during the exposure the stage is moved at a constant velocity in one horizontal direction by the moving mechanism.

3. The method according to claim 1, wherein there are a plurality of the OFF states.

4. The method according to claim 1, wherein appearance timing of an ON state divided by the OFF states is symmetrical in the region corresponding to the bit pattern.

5. The method according to claim 1, wherein when bit patterns to be exposed are consecutive, appearance timing of the ON state divided by the OFF states is periodically uniform in the consecutive bit patterns.

6. A method for manufacturing magnetic recording medium by using the imprint method, the method comprising:
forming a resist original disk by irradiating an electron beam by using the electron beam irradiating method according to claim 1;
forming a stamper to be used for an imprint method by using the resist original disk; and
forming a magnetic recording medium by using the stamper.

7. The method according to claim 6, wherein during the exposure the stage is moved at a constant velocity in one horizontal direction by the moving mechanism.

8. The method according to claim 6, wherein there are a plurality of the OFF states.

9. The method according to claim 6, wherein appearance timing of an ON state divided by the OFF states is symmetrical in the region corresponding to the bit pattern.

10. The method according to claim 6, wherein when bit patterns to be exposed are consecutive, appearance timing of the ON state divided by the OFF states is periodically uniform in the consecutive bit patterns.

11. A magnetic recording medium manufactured by using the method according to claim 6.

12. The magnetic recording medium according to claim 11, wherein during the exposure the stage is moved at a constant velocity in one horizontal direction by the moving mechanism.

13. The magnetic recording medium according to claim 11, wherein there are a plurality of the OFF states.

14. The magnetic recording medium according to claim 11, wherein appearance timing of an ON state divided by the OFF states is symmetrical in the region corresponding to the bit pattern.

15. The magnetic recording medium according to claim 11, wherein when bit patterns to be exposed are consecutive, appearance timing of the ON state divided by the OFF states is periodically uniform in the consecutive bit patterns.
